(19) United States
(12) Patent Application Publication
(10) Pub. No.: US 2008/0122948 A1
(43) Pub. Date: May 29, 2008

(54) WEB CAMERA

(75) Inventors: Fong-Ming Chang, Taipei (TW); Chih-Hong Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/770,743

(22) Filed: Jun. 29, 2007

(30) Foreign Application Priority Data
Jun. 30, 2006 (TW) 95123738

(51) Int. Cl. H04N 5/76; H04N 5/225

(52) U.S. Cl. 348/231.99; 348/207.1; 348/E05.024

(57) ABSTRACT

A web camera suitable for capturing an image data and storing the image data in a portable storage device is provided. The web camera includes a photosensitive device, a processing chip, and a dynamic image processing chip. The photosensitive device is suitable for capturing the image data. The processing chip is coupled to the photosensitive device and is suitable for receiving the image data output by the photosensitive device. The dynamic image processing chip is coupled to the processing chip. When the image data is a dynamic image data, the dynamic image processing chip outputs a control signal to the processing chip, and the processing chip stores the image data into the portable storage device according to the control signal.

### CROSS-REFERENCE TO RELATED APPLICATION

This application claims the priority benefit of Taiwan application serial no. 95123738, filed Jun. 30, 2006. All disclosure of the Taiwan application is incorporated herein by reference.

### BACKGROUND OF THE INVENTION

1. Field of the Invention

The present invention relates to an image capturing device. More particularly, the present invention relates to a web camera.

2. Description of Related Art

Along with the growth of economy and the increase of crime rates in urban area, public security is deteriorated day by day and household security is also threatened. To protect the safety of the family and to promote the living security quality of the entire family, except Neighborhood Watch programs, proper protection methods are required for effectively preventing the occurrence of crimes. Thus, different types of monitoring systems are developed one by one.

Moreover, the monitoring system is also being constructed over network due to the development of the Internet. For example, the images captured by a monitor are transferred to another server through the network. Presently, the images captured by web camera have reached some certain standard. However, such web camera has to be controlled by a computer to achieve its monitoring function.

### SUMMARY OF THE INVENTION

Accordingly, the present invention is directed to provide a web camera which can perform environment monitoring independently without using a computer or a hand-held electronic device.

To achieve the aforementioned and other objectives, the present invention provides a web camera, which is suitable for capturing an image data and storing the image data into a portable storage device. The web camera includes a photosensitive device, a processing chip, and a dynamic image processing chip. Wherein, the photosensitive device is suitable for capturing an image data. The processing chip is coupled to the photosensitive device and is suitable for receiving the image data output by the photosensitive device. The dynamic image processing chip is coupled to the processing chip. When the image data is a dynamic image data, the dynamic image processing chip outputs a control signal to the processing chip, and the processing chip stores the image data to a portable storage device according to the control signal.

According to an embodiment of the present invention, the web camera further includes a transmission cable which is suitable for being electrically connected to a computer or an electrical outlet.

According to an embodiment of the present invention, the web camera further includes a startup switch coupled to the processing chip for starting up the processing chip.

According to an embodiment of the present invention, the photosensitive device may be a charge coupled device (CCD) or a complementary metal-oxide semiconductor (CMOS) device.

According to an embodiment of the present invention, the processing chip may be a digital signal processor (DSP).

According to an embodiment of the present invention, the portable storage device may be a memory card or a portable hard disk.

As described above, according to the present invention, the web camera can perform environment monitoring independently without using a computer or a hand-held electronic device. Moreover, the web camera in the present invention has a dynamic image processing chip so that meaningless or blank image data will not be stored into the portable storage device.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a web camera according to an embodiment of the present invention.

FIG. 2 is a schematic block diagram of a web camera according to an embodiment of the present invention.

FIG. 3 is an operation flowchart of a web camera according to an embodiment of the present invention.

### DESCRIPTION OF EMBODIMENTS

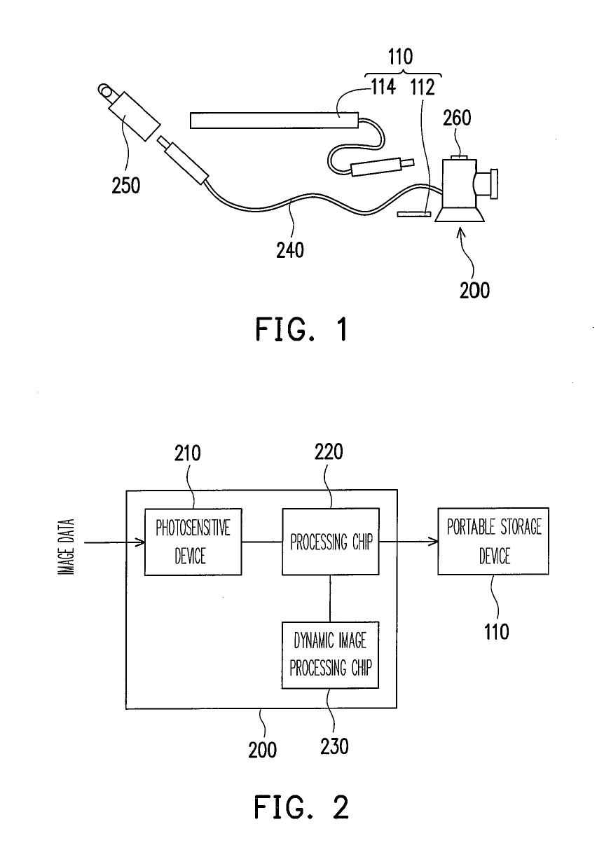

FIG. 1 is a diagram of a web camera according to an embodiment of the present invention, and FIG. 2 is a schematic block diagram of a web camera according to an embodiment of the present invention. Referring to FIG. 1 and FIG. 2, in the present embodiment, the web camera 200 is suitable for capturing an image data and storing the image data into a portable storage device 110, and the portable storage device 110 is, for example, a memory card 112 or a portable hard disk 114. The web camera 200 includes a photosensitive device 210, a processing chip 220, and a dynamic image processing chip 230. Wherein, the photosensitive device 210 is suitable for capturing an image data and is, for example, a charge coupled device (CCD) or a complementary metal-oxide semiconductor (CMOS) device. The processing chip 220 is coupled to the photosensitive device 210 and is suitable for receiving the image data output by the photosensitive device 210 and converting the image data into RGB data. Besides, the processing chip 220 is, for example, a digital signal processor (DSP).

The dynamic image processing chip 230 is coupled to the processing chip 220 and is used for determining whether the received image data is a dynamic image data. The dynamic image processing chip 230 outputs a control signal to the processing chip 220 when the dynamic image processing chip 230 determines that the received image data is a dynamic image data. Then, the processing chip 220 stores the corresponding image data to the portable storage device 110 according to the control signal. When the dynamic image processing chip 230 detects that a moving object appears in the area monitored by the web camera 200, the dynamic image processing chip 230 sends the control signal to the processing chip 220 and the processing chip 220 stores the corresponding image data into the portable storage device 110. It should be noted that in the present embodiment, the web camera 200 itself can directly perform environment monitoring instead of monitoring the environment through personal computer, notebook computer, or other electronic devices.

During the process of environment monitoring, the image data received by the web camera 200 is usually static pictures, and the dynamic image processing chip 230 determines whether a moving object appears in the received image data to determine whether to store the corresponding image data, thus, meaningless or blank image data will not be stored into the portable storage device 110.

Moreover, the power supply of the web camera 200 may be from a battery, or the web camera 200 may further include a transmission cable 240 and a converter 250 so that the electricity of an electrical outlet (not shown) can be provided to the web camera 200 through the converter 250 and the transmission cable 240. Besides, the transmission cable 240 may also be directly connected to a computer or other electronic devices for transmitting data. Moreover, the web camera 200 may also have a startup switch 260 coupled to the processing chip 220, and the startup switch 260 is suitable for starting up the processing chip 220 for performing environment monitoring. However, a remote controller or other wireless devices may also be used for starting up the environment monitoring function of the web camera 200. Below the operation of the web camera 200 will be described in detail.

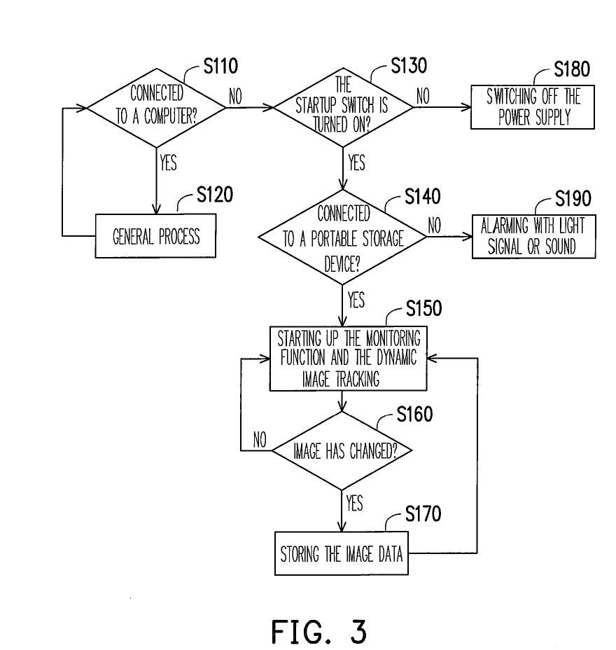

FIG. 3 is an operation flowchart of a web camera according to an embodiment of the present invention. Referring to FIG. 3 and FIG. 2, the operation of the web camera 200 includes the following steps. First, step S110 is executed for determining whether the web camera 200 is connected to a computer. A general process is proceeded if the web camera 200 is connected to a computer. For example, images are transmitted instantly or static pictures are taken. If the web camera 200 is not connected to a computer, step S130 is executed for determining whether the startup switch is turned on. Step S180 is executed for switching off the power supply if the startup switch is not turned on. Step S140 is executed for determining whether the web camera 200 is connected to the portable storage device 110 if the startup switch is turned on. If the web camera 200 is not connected to the portable storage device 110, step S190 is executed for alarming the user with light signal or sound.

If the web camera 200 is connected to the portable storage device 110, step S150 is executed to start up the monitoring function and the dynamic image tracking function. Then, step S160 is executed to determine whether the image has changed. In specific, here the dynamic image processing chip 230 determines whether the image has changed, that is, whether a moving object appears in the area monitored by the web camera 200. If the image does not change, the monitoring state is maintained as in step S150. If the image has changed, step S170 is executed for storing the image data, that is, the processing chip 220 stores the image data containing the moving object into the portable storage device 110. Here, the dynamic image processing chip 230 can constantly judge whether the image has changed to determine whether to store the image data continuously (step S150). Or, the dynamic image processing chip 230 determines whether the image has changed (step S150) after storing image data continuously for some time.

In overview, the web camera in the present invention has at least the following advantages:
1. The web camera in the present invention has a dynamic image processing chip which can determine whether a moving object appears in a monitored area, so as to determine whether to store the corresponding image data, thus, meaningless or blank image data will not be stored into the portable storage device.
2. The web camera in the present invention can perform environment monitoring independently without using a computer or a hand-held electronic device.
3. The web camera in the present invention has environment monitoring function besides the general functions of the conventional web cameras.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A web camera, suitable for capturing an image data and storing the image data into a portable storage device, the web camera comprising:
a photosensitive device, suitable for capturing the image data;
a processing chip, coupled to the photosensitive device, suitable for receiving the image data output by the photosensitive device; and
a dynamic image processing chip, coupled to the processing chip,
wherein the dynamic image processing chip outputs a control signal to the processing chip, and the processing chip stores the image data into the portable storage device according to the control signal, when the image data is a dynamic image data.

2. The web camera as claimed in claim 1, further comprising a transmission cable suitable for being electrically connected to a computer or an electrical outlet.

3. The web camera as claimed in claim 1, further comprising a startup switch coupled to the processing chip, the startup switch being suitable for starting up the processing chip.

4. The web camera as claimed in claim 1, wherein the photosensitive device comprises a charge coupled device or a complementary metal-oxide semiconductor device.

5. The web camera as claimed in claim 1, wherein the processing chip comprises a digital signal processor.

6. The web camera as claimed in claim 1, wherein the portable storage device comprises a memory card or a portable hard disk.
